(19) United States
(12) Patent Application Publication
(10) Pub. No.: US 2008/0223997 A1
(43) Pub. Date: Sep. 18, 2008

(54) DRIPLESS COLLAR

(75) Inventor: Sarah S. Peterson, Philadelphia, PA (US)

Correspondence Address: BLACK LOWE & GRAHAM, PLLC, 701 FIFTH AVENUE, SUITE 4800, SEATTLE, WA, 98104, US

(73) Assignee: Progressive International Corporation, Kent, WA (US)

(21) Appl. No.: 12/035,385

(22) Filed: Feb. 21, 2008

Related U.S. Application Data
(60) Provisional application No. 60/890,993, filed on Feb. 21, 2007.

(51) Int. Cl. F16M 11/00

(52) U.S. Cl. 248/176.1

(57) ABSTRACT

A collar for a cooking utensil is configured to retain the utensil within the collar and hold the working end of the utensil above a countertop or other horizontal surface. In a preferred form, the collar is formed in two halves pivotally connected with one another, with an interior region of flexible material that deforms about a utensil handle to retain the handle within the collar. Magnets or other fasteners keep the collar halves joined together.

### PRIORITY CLAIM

This application claims the benefit of Provisional Patent Application Ser. No. 60/890,993 filed on Feb. 21, 2007 of which are incorporated herein by reference in its entirety.

### FIELD OF THE INVENTION

This invention relates generally to kitchen utensils.

### BACKGROUND OF THE INVENTION

A variety of utensils may be used while cooking, such as spoons, whisks, ladles, and spatulas. When the utensil is used, it may become soiled with the food that is being prepared. If the utensil is placed on a countertop, it may create a mess on the countertop, leaving remnants of food behind. In some instances, perhaps with certain sauces for example, the food from the utensil may stain the countertop. As a related problem, the countertop may not be perfectly sanitary because, for example, it was recently used for cutting meats. There is therefore a need for a device that can elevate the utensil tool head above the countertop to reduce the potential mess and eliminate the need for a spoon rest or similar device.

### BRIEF DESCRIPTION OF THE DRAWINGS

Preferred and alternative embodiments of the present invention are described in detail below with reference to the following drawings:

FIG. 1 is a front view of an exemplary collar;

FIG. 2 is an end view of an exemplary collar;

FIG. 3 is a front view of an exemplary collar pivoted into an open position;

FIG. 4 is an end view of an exemplary collar pivoted into an open position;

FIG. 5 is a perspective view of an exemplary collar pivoted into an open position; and

FIG. 6 is a perspective view of an exemplary collar shown attached to a utensil.

### DETAILED DESCRIPTION OF THE PREFERRED EMBODIMENT

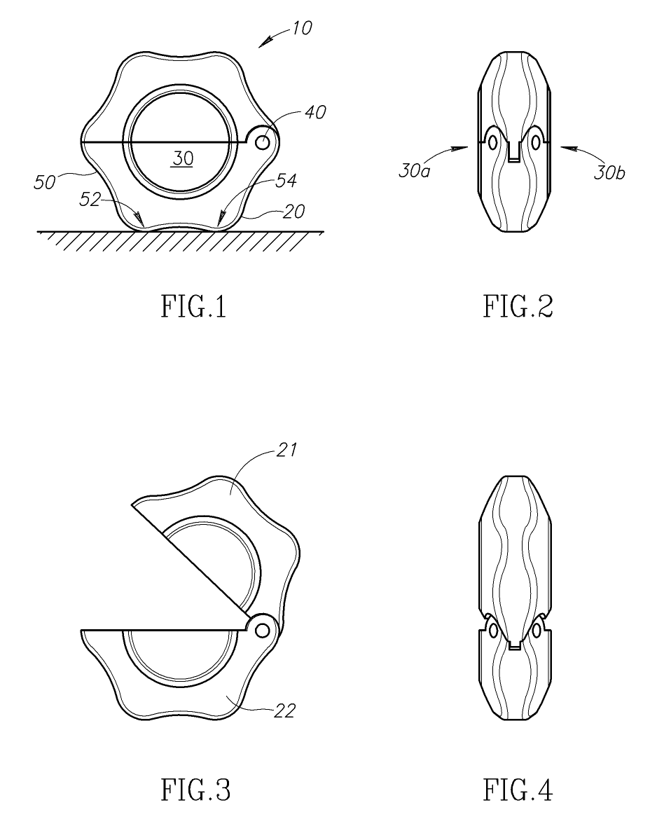

An exemplary collar is shown in FIG. 1. As illustrated, the collar 10 includes a generally rigid outer rim 20 formed in a generally circumferential shape. A relatively more flexible interior portion 30 lies radially inward of the outer rim 20 and is configured to receive and retain a cooking utensil. In the form as shown, the outer rim 20 is formed in two halves pivotally connected at a pivot point 40.

The outer rim 20 may be formed in any shape. In one example, it is substantially circular. Preferably, however, the outer rim has at least one side that is either flat or that has at least two points 52, 54 that will contact a flat surface such as a countertop 60 to provide stability. Configured in that manner, the collar 10 will rest on a flat surface without rolling away and onto the floor. In the example as shown, the circumferential shape of the outer rim 20 is that of a smoothed hexagon having scalloped sides. It may alternatively be triangular, square, pentagonal, or any other shape (with our without scalloping or other aesthetic shapes). Likewise, the shape of the outer rim may be generally circular except for a single region that is flattened and therefore has at least two points that will contact the countertop.

In a preferred example, the outer rim 20 of the collar is made from Polypropylene or a similarly substantially rigid plastic. It may alternatively be constructed from other materials, including wood or metal, for example. In other examples it may be made from rigid or semi-rigid materials, including rubber or silicone or other materials over-molded onto plastic or other base materials.

The pivot 40 may be formed from mating sections of threaded fasteners, rivets, or other fasteners. As additional alternatives, the two halves of the outer rim 21, 22 may include complementary fastening sections, such as male and female fastening sections that snap-fit together to provide a pivotal attachment.

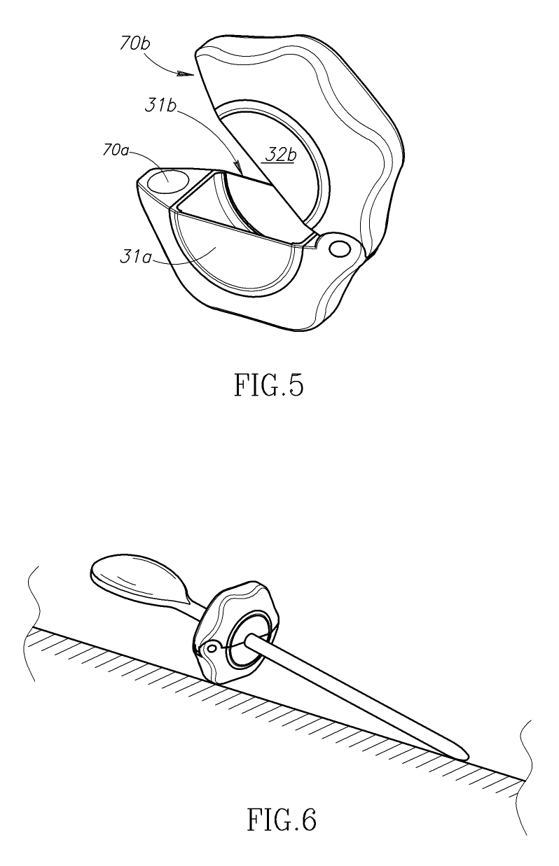

The interior portion 30 includes two resilient walls 30a, 30b (one on each side of the device, as shown in FIG. 2) to retain the tool head and keep it stabilized. Each of the two walls 30a, 30b is further divided into an upper portion and a lower portion. In FIG. 5, lower interior resilient walls 31a and 31b are visible, as is upper interior resilient wall 32a. The interior portion is configured to flexibly retain a variety of utensils having a variety of shapes. In the preferred form, this is accomplished by using a flexible material such as TPR for the interior portion and further by forming the interior portion in a thickness sufficient to allow the interior portion to deflect and surround a utensil when the two halves of the outer rim are joined together.

As shown in the preferred form, the interior portion 30 is formed such that opposing sides of the upper and lower halves of the interior portion fully define a circle when joined together. Alternatively, a central portion of the interior region may be formed with a bore, thereby defining an annular or “donut” shape. In such a configuration, it may be desirable to use a thicker or somewhat more rigid construction for the interior region. As illustrated, the interior region may be considered flexible; in the annular alternative embodiment, it may be considered semi-rigid such that it will still deflect to accept a variety of tools, but the range of deflection can be narrower due to the central bore.

As best seen in FIG. 5, each half of the outer rim 21, 22 includes a complementary or mating fastener to hold the halves of the rim together around a utensil. In the preferred example, the fastener comprises an embedded magnet 70a, 70b in each half of the outer rim. The magnets are sufficiently strong to firmly secure the halves together about a tool. In alternate forms, clips, snaps, or other fasteners may be used.

In order to use the collar, the two halves of the outer rim are pivoted to open the collar. A kitchen utensil is placed between the halves of the collar, which is then pivoted closed again to hold the utensil in a desired location. As shown in FIG. 6, the utensil is then configured so that the working end will be suspended above the countertop when the tool is placed on the countertop.

While the preferred embodiment of the invention has been illustrated and described, as noted above, many changes can be made without departing from the spirit and scope of the invention. For example, the tool may be made with a single annular outer rim, without the use of a pivot. In such a form, the tool is simply slid down the handle of a utensil to a desired location. As another example, the interior portion may be formed as a single wall, rather than with two opposing walls 30a, 30b as shown. In still another example, the collar may be formed from a single material (rather than a hard outer rim and more resilient central portion) having a central opening to receive the handle of a utensil. Accordingly, the scope of the invention is not limited by the disclosure of the preferred embodiment.

I claim:

1. A collar for a cooking utensil, comprising:
a first collar portion having a perimeter and a first interior region;
a second collar portion pivotally attached to the first collar portion, the second collar portion having a perimeter and a second interior region;
a first fastener attached to the first collar portion; and
a second fastener attached to the second collar portion, the first and second fasteners being configured to mate with one another;
the first interior region being formed from a resilient material sized and configured to deform about a portion of the cooking utensil adjacent a working end of the cooking utensil;
whereby the collar supports the working end of the cooking utensil above a horizontal surface on which the cooking utensil is placed.

2. The collar of claim 1, wherein the second interior region is formed from a resilient material sized and configured to deform about a portion of the cooking utensil adjacent a working end of the cooking utensil.

3. The collar of claim 1, wherein the first fastener comprises a first magnet and the second fastener comprises a second magnet.

4. The collar of claim 1, wherein at least one of the first collar portion and second collar portion comprises a flat region on an outer perimeter.

5. The collar of claim 1, wherein the first collar portion further comprises a perimeter, the perimeter having at least one scalloped edge.

6. The collar of claim 1, wherein the first collar portion and second collar portion comprise a perimeter, the perimeter having a hexagon shape.

7. The collar of claim 6, wherein the hexagon shape further comprises six sides, at least one of the sides being scalloped.

8. The collar of claim 1 wherein the first interior region comprises a first wall and an opposing second wall, the first and second walls defining an interior space.

9. The collar of claim 8, wherein the second interior region comprises a third wall and an opposing fourth wall, the first wall mating with the third wall and the second wall mating with the fourth wall when the first and second collar portions are pivoted to a closed position.

10. The collar of claim 1, wherein the first and second fasteners comprise mating snaps.

11. The collar of claim 1, wherein a central portion of the first interior region comprises a first bore.

12. The collar of claim 11, wherein a central portion of the second interior region comprises a second bore.

13. A device for a cooking utensil, comprising:
a collar having a perimeter and an interior region, the perimeter being relatively more rigid than the interior region, the interior region being configured to enable a handle of the cooking utensil to pass through the interior region, thereby retaining the cooking utensil within the collar;
whereby the collar supports the working end of the cooking utensil above a horizontal surface on which the cooking utensil is placed.

14. The collar of claim 13, further comprising:
a first collar portion and a second collar portion pivotally attached to the first collar portion; and
a pair of mating fasteners securing the first and second collar portions in a closed position.

15. The collar of claim 13, wherein a central portion of the first interior region comprises a first bore.

16. The collar of claim 13, wherein at least one of the first collar portion and second collar portion comprises a flat region on an outer perimeter.

17. The collar of claim 13, wherein the first collar portion further comprises a perimeter, the perimeter having at least one scalloped edge.

18. The collar of claim 13, wherein the first collar portion and second collar portion comprise a perimeter, the perimeter having a hexagon shape.

19. The collar of claim 18, wherein the hexagon shape further comprises six sides, at least one of the sides being scalloped.
